(19) United States
(12) Patent Application Publication
(10) Pub. No.: US 2015/0165461 A1
(43) Pub. Date: Jun. 18, 2015

(54) PRESSURIZED CONTAINER

(71) Applicants: Takao Mizuki, Shunan-shi (JP); Goichi Mizuki, Shunan-shi (JP); Kazue Jo, Shunan-shi (JP); Kenji Mizuki, Shunan-shi (JP); Satoko Mizuki, Shunan-shi (JP)

(72) Inventors: Takao Mizuki, Shunan-shi (JP); Goichi Mizuki, Shunan-shi (JP); Kazue Jo, Shunan-shi (JP); Kenji Mizuki, Shunan-shi (JP); Satoko Mizuki, Shunan-shi (JP)

(21) Appl. No.: 14/411,457

(22) PCT Filed: May 14, 2013
(86) PCT No.: PCT/JP2013/063465

§ 371 Date: Dec. 26, 2014

(30) Foreign Application Priority Data
Jun. 27, 2012 (JP) 2012-144802

(51) Int. Cl. F17C 1/00

(52) U.S. Cl. CPC B05B 11/06; B05B 11/00; B05B 12/008

(57) ABSTRACT

There is provided a pressurized container provided with sealing members which can be manufactured at a low cost, minimally causes a defect, and can increase sealing property by making use of a pressure of a fluid in the pressurized container. The pressurized container (1k) has the structure where an annular space portion (16) is formed between facing surfaces of sealing members (7, 7), an air supply/discharge hole (17) is provided so as to adjust an inner pressure in the annular space portion (16), and air supply/discharge means (18) is connected to the air supply/discharge hole (17). The sealing members (7) are formed such that an area of a sealing surface (5a) is smaller than an area of a pressure receiving surface (5b).

### TECHNICAL FIELD

The present invention relates to a pressurized container provided with a sealing member having excellent sealing property while having the simple structure, and more particularly to a pressurized container used in a state where a pressure of a fluid in the container is higher than a pressure of a fluid outside the container.

### BACKGROUND ART

In a joining portion of a structural body such as a pipe, a pressurized container or a wall member, usually, a sealing member such as a gasket is mounted so as to prevent a fluid such as a liquid or a gas in the structural body from leaking to the outside or to prevent the intrusion of a foreign substance or the like into the inside of the structural body from the outside of the structural body, and sealing of the joining portion is ensured by a fastening force generated by bolts or the like and a compressive reactional force of the sealing member. However, the performance of the sealing member extremely largely influences the safety of the pipe, the pressurized container or the like. In view of the above, conventionally, various studies have been made to increase sealing property of the joining portion. Further, several inventions and petty inventions have been already disclosed with respect to the enhancement of sealing property of the joining portion.

For example, patent document 1 discloses the invention having Title of the Invention “Gasket and joint” which relates to a gasket having excellent corrosion resistance and excellent high temperature resistance, and a joint where such a gasket is used at a knife edge flange having a projecting edge on a sealing face thereof.

The joint according to the invention disclosed in patent document 1 has the structure where a projecting portion is formed on the flange sealing face, the gasket containing iron at the content of 99.95% or more and having the sealing face with Vickers hardness of 50 Hv to 100 Hv is disposed between a set of vacuum flanges having a magnetic force.

Due to such a structure, compared to the case where a copper gasket is used, the corrosion resistance and the high temperature resistance of the joint can be enhanced. Further, the gasket can be fixed to the flange sealing face by a magnetic force and hence, the displacement is minimally generated at the time of mounting the flange on the gasket.

Further, patent document 2 discloses the invention having Title of the Invention “Method of manufacturing metal joint structure and inner gland” which relates to a method of manufacturing a metal joint used in a pipe for a high vacuum or for making a particular gas flow therethrough and inner glands for the metal joint.

The metal joint which relates to the invention disclosed in patent document 2 includes: a gasket made of a clean stainless steel to which mirror finish is applied; and inner glands made of a clean stainless steel, the inner glands being arranged while facing each other with a gasket sandwiched therebetween. On an end face of each of the inner glands, an annular projecting portion is formed, wherein the annular projecting portion has higher hardness than the gasket, has an approximately semicircular cross-sectional shape, and can be pushed only from the direction perpendicular to front and back surfaces of the gasket by flange members provided as separate bodies.

In the metal joint having such a structure, mirror finish is applied to both a contact surface of the gasket and a contact surface of the inner gland and hence, the metal joint exhibits high sealing performance. Further, the annular projecting portion has an approximately semicircular cross section and hence, a contact state between the annular projecting portion and the gasket becomes stable. Further, since the annular projecting portion has the structure which generates a fastening force acting only in the direction perpendicular to the gasket and hence, flaws are minimally generated on the contact surface with the gasket.

Further, patent document 3 discloses the invention having Title of the Invention “Ultra airtight pipe joint” which relates to a pipe joint used in a device which uses an ultra high vacuum.

The invention disclosed in patent document 3 discloses the structure where, in a pipe joint where a gasket disposed between sealing bolts and a seal tube is clamped by the threaded engagement of cap nuts with sealing bolts, the gasket is formed of a metal C ring where a sealing face is formed into a mirror face, and a holder is mounted on a surface of the seal bolt which faces the seal tube such that a retainer ring which is engaged with an opening portion of the metal C ring can be held.

In the pipe joint having such a structure, even when the sealing face is directed sideward or downward, the fall of the gasket from the seal bolt can be prevented.

This pipe joint structure is a technique which prevents a fluid stored in the inside of a container from being leaked to the outside by applying fact that gauge blocks cannot be separated from each other when the gauge blocks are made to abut each other in the atmosphere to a portion of a joint of a pressurized container.

Next, according to FIG. 2 of patent document 4, a base portion surface 10 of a projecting portion 9 which projects from an inner surface of a cylindrical member 1 of a pressurized container forms a pressure receiving face which receives a pressure of a fluid which is a high pressure on an inner pressure side. A contact surface 11 which is a flat smooth surface forms a seal face. Further, there is a description in patent document 4 that the projecting portion 9 is elastically deformed. This proposal intends to perform sealing by making use of a pressure of a fluid in the container.

Next, patent document 5 discloses the invention having Title of the Invention “Seal structure of flange portion of vacuum container and sealing method” which relates to the seal structure of a vacuum container. Since the container is a vacuum container, it is a matter of course that sealing can be performed by making use of an outer pressure by paying attention to a blind flange shown in FIG. 2 since a pressure outside the container is higher than a pressure inside the container.

### PRIOR ART DOCUMENTS

### Patent Documents

Patent Document 1: JP 2004-190735 A

Patent Document 2: JP 8-312851 A

Patent Document 3: JP 2-16892 U

Patent Document 4: JP 58-174761 A

Patent Document 5: JP 60-118063 U

### SUMMARY OF THE INVENTION

### Problems to be Solved by the Invention

However, the invention disclosed in patent document 1 which is the above-mentioned related art has a drawback that sealing property cannot be increased exceeding the conventional sealing property although the invention has advantages that the gasket has the substantially same hardness as in the case of using a copper gasket and can enhance collusion resistance and high temperature resistance. Further, the gasket is deformed due to a fastening force generated by bolts and a magnetic force and hence, when the deviation of the center of the flange or the temporary displacement of the flange occurs, there arises a drawback that fluid leaks. Further, the prior art also has a drawback that it is difficult to maintain a fastening force of the bolts to be uniform.

Further, the invention disclosed in patent document 2 adopts the structure where a fluid enters between the gasket and the inner gland from a flow passage and hence, when the structure is used as a joint of pipes in which a high-pressure fluid flows therein, a force in the direction opposite to a fastening force of a bolt is generated due to a pressure of the fluid, thus giving rise to a possibility that sealing property between the gasket and the inner gland is lowered.

Further, according to the invention disclosed in patent document 3, an operation of mounting the gasket on the sealing bolt can be easily performed. However, the structure of a joining portion between the sealing bolt and the sealing tube and the structure which holds the gasket become complicated, thus giving rise to a drawback that the joint cannot be manufactured at a low cost. Further, the joint adopts the structure where a fluid in the tube enters between a sealing surface of the sealing bolt and the gasket or between the sealing surface of the sealing tube and the gasket and hence, when a pressure of the fluid is high, the fluid acts so as to separate the sealing bolt, the sealing tube and the gasket from each other by pulling, thus giving rise to a possibility that sealing property is lowered. Accordingly, the joint of this invention has a drawback that the joint is not applicable to a pipe for a high-pressure fluid.

Further, with respect to patent document 4, to observe an area on a plane perpendicular to an axis of the container shown in FIG. 2, an area of an inner side of an outer periphery of the container is largest, an area Sₐ of an inner side of the container is the second largest, an area of a sealing surface is the third largest, and an area of a pressure receiving surface which receives a pressure of an inner fluid as the fourth area which is the last area becomes the smallest.

There is no description relating to these areas in the specification. There is also no description with respect to an axial force W of the bolt.

Accordingly, what can be said on the basis of only areas on plane perpendicular to the axis of the container specifically apparent as observed by naked eyes is that assuming the area of the pressure receiving surface as Sⱼ and the area of the sealing surface when the projecting portion 9 is not provided as S_{b}, the area of the sealing surface of the container becomes S_{b}+Sⱼ.

That is, it is estimated that a fluid pressure received by the pressure receiving surface is defused over the sealing area larger than the pressure receiving surface and hence, it is difficult to always maintain the surface pressure of the sealing surface higher than a pressure of an inner fluid.

That is, assuming a pressure of a fluid in the container as Pₐ and a surface pressure of the sealing surface as Pₛ, the relationship Pₐ Sⱼ=Pₛ (S_{b}+Sⱼ) is established, and this relationship is also expressed as Pₛ=Pₐ Sⱼ/(S_{b}+Sⱼ). Since the relationship Sⱼ<S_{b}+Sⱼ is established, the relationship Pₛ<Pₐ is established and hence, it is estimated that it is difficult to set the sealing surface pressure higher than the fluid pressure.

Further, in patent document 5, in the vacuum container, a sealing surface pressure inevitably becomes higher than a fluid pressure and hence, this technique is excluded from the scope of this proposal.

So far as the background art is observed within the above-mentioned range, there has not been established a technique where a surface pressure of a sealing surface of a joint of a pressurized container is always held higher than a pressure of a fluid using the pressure of the fluid under a fixed condition.

With respect to a flange joint of a pressurized container, two cases are considered. One case is that when a surface pressure at sealing surfaces where facing sealing surfaces are pushed is lower than a pressure of a fluid on a high pressure side, the fluid on the high pressure side directly intrudes into the sealing surfaces. The other case is that with respect to the facing surfaces, when a fluid on a high pressure side is applied to a surface other than a sealing surface, a gap between facing surfaces is enlarged so that the gap between the sealing surfaces is increased, whereby the fluid on the high pressure side intrudes into the sealing surfaces. Once the fluid on the high pressure side intrudes to the sealing surfaces, the fluid enlarges the gap between the sealing surfaces due to a fluid pressure higher than a sealing surface pressure and hence, cross-sectional area of a fluid passage is enlarged and an intrusion area is also enlarged, whereby a load which separates the sealing surfaces from each other is increased.

On the other hand, when an area of surfaces of facing surfaces other than sealing surfaces to which a fluid pressure on a high pressure side is applied is minimized so that a surface pressure of the sealing surfaces is always set higher than a pressure of a fluid on a high pressure side, the intrusion of the fluid on a high pressure side into the sealing surfaces can be prevented. Even if a fluid on a high pressure side intrudes into the sealing surfaces due to an inadvertent factor, it is possible to discharge the intruded fluid from the sealing surfaces in this case.

From the reasons set forth above, there has been a demand for a technique which maintains a surface pressure of sealing surfaces of a joint of a pressurized container always higher than a pressure of a fluid using the pressure of the fluid in the container under a fixed condition.

Further, a technique is also dispensable where a plurality of sealing surfaces are provided in the same sealing member, a space is formed between facing surfaces, information on pressure, concentration, content or the like relating to the space is introduced into the inside or the outside of the container, and leakage of a large number on joints is controlled in a concentrated manner in real time at a safe place.

The present invention has been made to cope with the above-mentioned conventional circumstances, and it is an object of the present invention to provide a pressurized container provided with a sealing member which can be manufactured at a low cost, minimally causes a defect, and can increase sealing property by making use of a pressure of a fluid in the pressurized container.

### Solutions to the Problems

To achieve the above-mentioned object, the invention described in claim 1 is directed to a pressurized container used in a state where an inner pressure is higher than an outer pressure. The pressurized container includes a connecting portion where a pair of sealing members having a flat plate shape is disposed in a projecting manner toward the inside, each of the sealing members including a sealing surface and a pressure receiving surface on both front and back surfaces, and each of the sealing members is formed such that the at least one sealing surface is formed on an end surface of a projecting portion formed in a projecting manner in a direction opposite to the pressure receiving surface, and an area of the end surface of the projecting portion is set narrower than an area of the pressure receiving surface, and an area of the sealing surface is set narrower than the area of the pressure receiving surface.

In the pressurized container having such a structure, in one pair of sealing members, a pressure of a fluid applied to the pressure receiving surface acts so as to push the sealing surface to the sealing surface of the mating member. Further, in the pair of sealing members, even when the sealing surface of the mating member is formed into a projecting shape or a recessed shape, the sealing members have an action that sealing surfaces of the sealing members can be easily brought into close contact with each other. Further, the pair of sealing members has an action where the sealing surface is pushed to the sealing surface of the mating member by a pressure larger than a pressure of a fluid applied to the pressure receiving surface.

The invention described in claim 2 is, in the pressurized container described in claim 1, characterized in that the sealing members are formed such that an annular groove is formed on an inner wall surface over the whole circumference near the connecting portion.

In the pressurized container having such a structure, a pressure of a fluid which enters the inside of the annular groove is applied to a pressure receiving surface of the sealing member and hence, the sealing member has an action that the sealing surface is pushed to the sealing surface of the mating member.

The invention described in claim 3 is, in the pressurized container described in claim 1 or claim 2, characterized in that the sealing surface is constituted of a plurality of portions.

The pressurized container having such a structure has, in addition to the actions of the present invention described in claim 1 or claim 2, an action that a space portion is formed between a pair of facing sealing surfaces.

The invention described in claim 4 is, in the pressurized container described in any one of claims 1 to claim 3, characterized in that the pressurized container includes: an annular space portion formed between the facing surfaces of the sealing members; an air supply/discharge hole formed in the connecting portion such that the air supply/discharge hole has one end opened in the annular space portion; and air supply/discharge means connected to the other end of the air supply/discharge hole.

Such a pressurized container has, in addition to the actions of the invention described in any one of claim 1 to claim 3, an action that a gas in the annular space portion is discharged by the air supply/discharge means so as to set an inner pressure of the annular space portion lower than a pressure of a fluid, whereby a close contact force between the sealing surfaces is increased and, at the same time, a gas is supplied to the inside of the annular space portion by the air supply/discharge means so as to increase the inner pressure, whereby a close contact force between the sealing surfaces is decreased.

The invention described in claim 5 is, in the pressurized container described in claim 4, characterized in that the pressurized container includes pressure detection means which detects an inner pressure of an annular space portion.

Such a pressurized container has, in addition to the action of the invention described in claim 4, an action that the presence or non-presence of leakage of a fluid from the sealing surfaces is detected by detecting an inner pressure of the annular space portion using the pressure detection means.

### Effects of the Invention

According to the invention described in claim 1 of the present invention, sealing property in the connecting portion of the pressurized container can be easily increased. Further, since the structure of the sealing member is simple, the sealing member minimally causes a defect. In addition to such advantages, the sealing member can be manufactured at a low cost. Still further, sufficient sealing property can be ensured by increasing a close contact force between the sealing surfaces by making use of a pressure of a fluid.

According to the invention described in claim 2 of the present invention, a pressurized container acquiring advantageous effects substantially equal to the advantageous effects acquired by the invention described in claim 1 can be manufactured at a low cost.

According to the invention described in claim 3 of the present invention, advantageous effects substantially equal to the advantageous effect of the invention described in claim 1 or claim 2 can be acquired.

According to the invention described in claim 4 of the present invention, in addition to the acquisition of the advantageous effects of the invention described in any one of claim 1 to claim 3, when it is necessary to dismantle the pressurized container in operations such as maintenance and checking, a close contact force between the sealing surfaces can be decreased by increasing an inner pressure of the annular space portion, and hence the connecting portions can be easily separated from each other.

According to the invention described in claim 5 of the present invention, in addition to the acquisition of advantageous effects of the invention described in claim 4, an abnormal state that a fluid leaks can be speedily detected and hence, the occurrence of an accident can be prevented in advance.

### BRIEF DESCRIPTION OF THE DRAWINGS

FIG. 1(a) is a cross-sectional view showing a state where an Embodiment 1 of sealing members used in a pressurized container according to the mode for carrying out the present invention is mounted on a wall member of an airplane or the like, and FIG. 1(b) is a cross-sectional view of the pressurized container in which the sealing members are used.

FIG. 2(a) is a cross-sectional view showing a state where the embodiment 1 of sealing members used in a pressurized container according to the mode for carrying out the present invention is mounted on a wall member of an airplane or the like, and FIG. 1(b) is a cross-sectional view of the pressurized container in which the sealing members are used.

FIG. 3 (a) to FIG. 3(c) are views showing a modification of the pressurized container shown in FIG. 1 (a) or FIG. 2 (a).

FIG. 4 is a view showing a modification of the pressurized container shown in FIG. 1 (b).

FIG. 5 is a view showing a state where the sealing members are formed such that an area of a sealing surface is set narrower than an area of a pressure receiving surface in FIG. 1 (a).

FIG. 6 is a cross-sectional view showing a state where an Embodiment 2 of the sealing members used in the pressurized container according to the mode for carrying out the present invention is used in a pipe joint.

FIG. 7 is an enlarged view of a portion shown in FIG. 6.

FIG. 8 is a view showing a modification of the pipe joint shown in FIG. 6.

FIG. 9 is a view showing a modification of the pipe joint shown in FIG. 6.

FIG. 10 is a longitudinal cross-sectional view showing a state where an Embodiment 3 of the sealing members used in the pressurized container according to the mode for carrying out the present invention is used in a pipe joint.

FIG. 11 is a longitudinal cross-sectional view showing a state where an Embodiment 4 of the sealing members used in the pressurized container according to the mode for carrying out the present invention is used in pipe joints.

FIG. 12 is an enlarged view of a portion shown in FIG. 11.

FIG. 13 is a view showing a modification of the pipe joints shown in FIG. 11.

FIG. 14 is a view showing a modification of the pipe joints shown in FIG. 11.

FIG. 15 is a longitudinal cross-sectional view showing a state where an Embodiment 5 of the sealing members used in the pressurized container according to the mode for carrying out the present invention is used in a pipe joint.

FIG. 16 is an enlarged view of a portion shown in FIG. 15.

FIG. 17 is a longitudinal cross-sectional view of an Embodiment 6 of the pressurized container according to the mode for carrying out the present invention.

FIG. 18 is a longitudinal cross-sectional view showing a state where an Embodiment 7 of the sealing members used in the pressurized container according to the mode for carrying out the present invention is used in a connecting portion of wall members of a fuselage or a compartment of an airplane or the like.

### EMBODIMENTS OF THE INVENTION

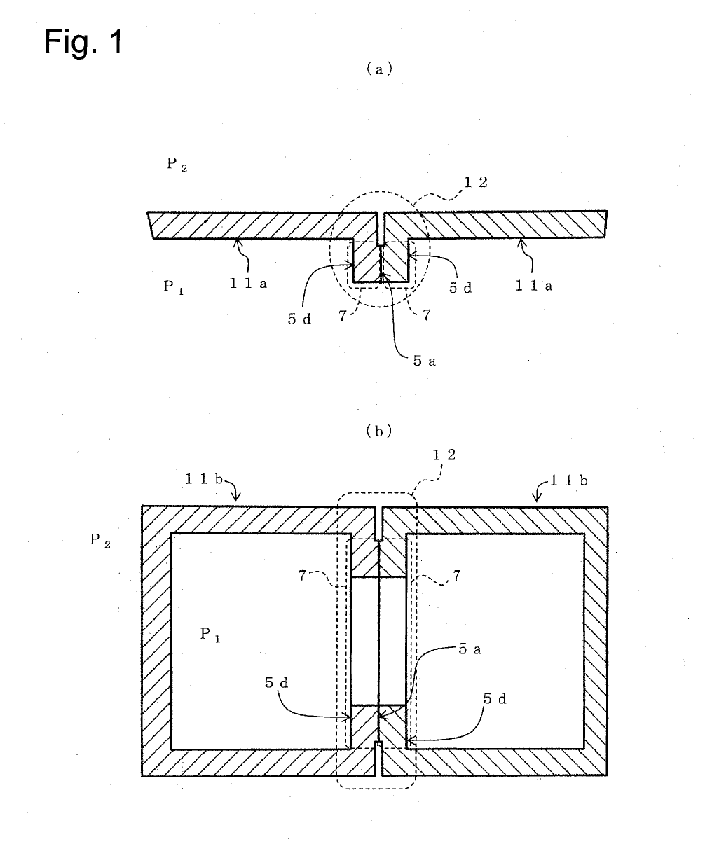

The constitution of the present invention and the manner of the operation and advantageous effects based on the constitution are specifically described by reference to FIG. 1 to FIG. 18 by taking a pressurized container according to embodiments of the present invention and cases where sealing members used in the pressurized container are used in a connecting portion of wall members and pipe units as examples.

### Embodiment 1

Sealing members of this embodiment are used in a connecting portion of a structural body such as a wall member of a ship, an airplane or the like or a pressurized container used in a state where the pressure difference is generated between a fluid such as a liquid or a gas existing in the structural body and a fluid such as a liquid or a gas existing outside the structural body. Hereinafter, the structure of the connecting portion is described using FIG. 1 to FIG. 5.

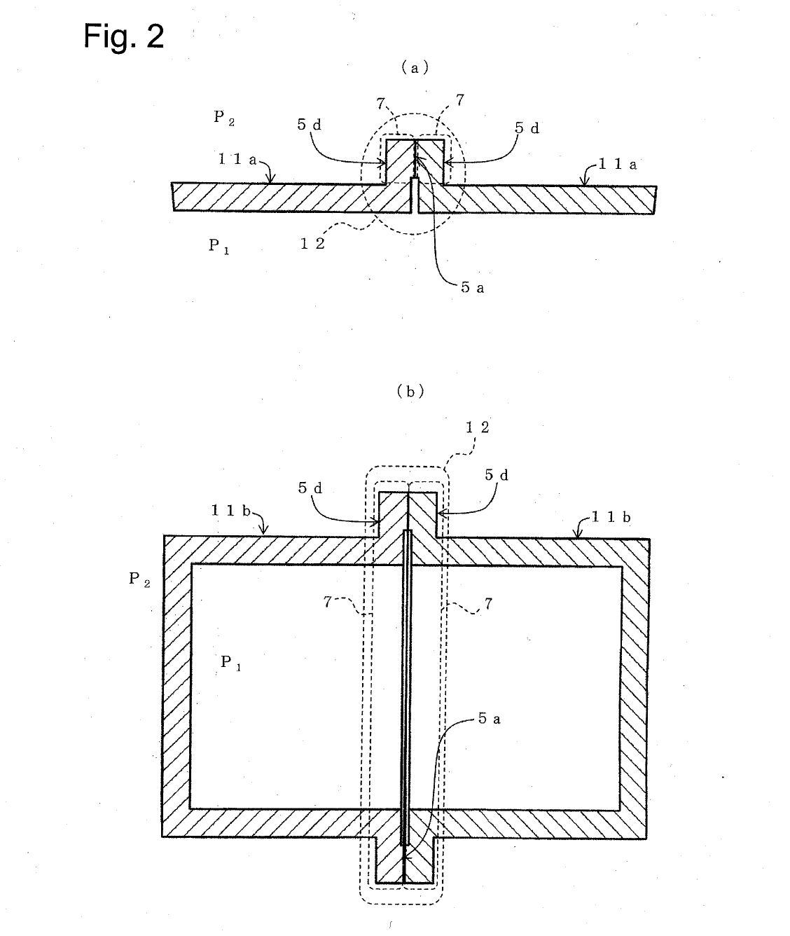

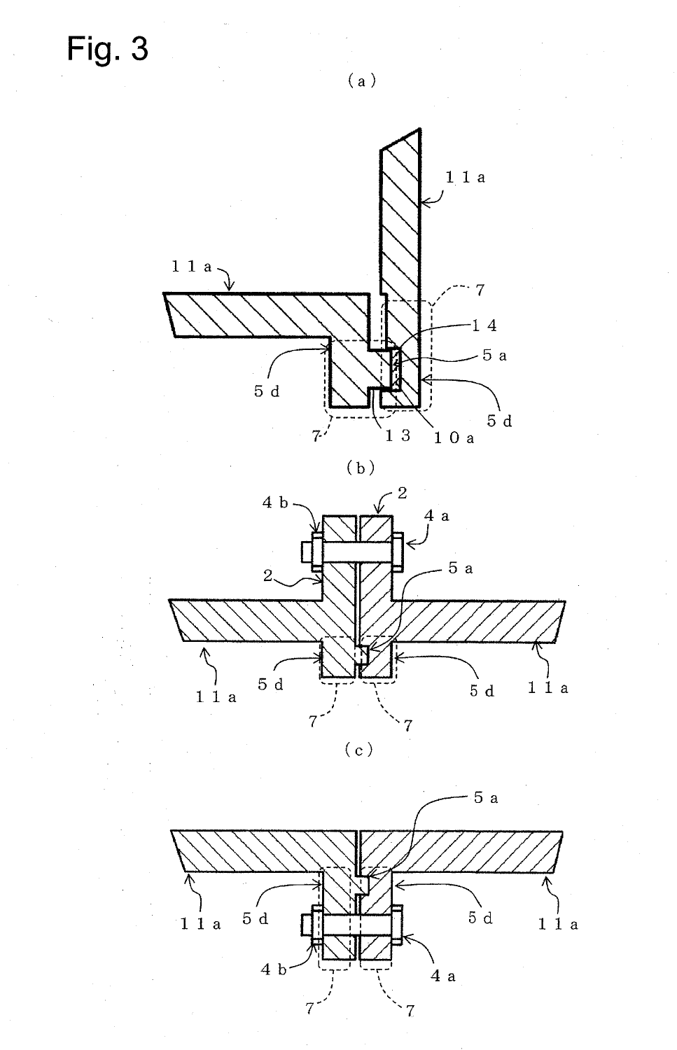

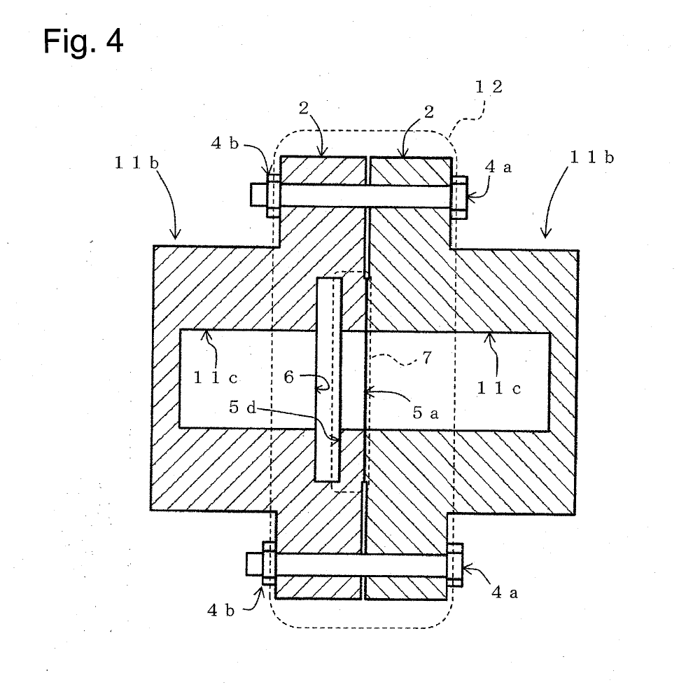

FIG. 1 to FIG. 5 are cross-sectional views showing a state taken along planes respectively orthogonal to a wall member and a sealing member or a wall surface of a pressurized container and a sealing member. FIG. 1(a) and FIG. 1(b) correspond to the case where an inner pressure P₁ is higher than an outer pressure P₂, and FIG. 2(a) and FIG. 2(b) correspond to the case where the outer pressure P₂ is higher than the inner pressure P₁. FIG. 3 and FIG. 4 show a modification shown in FIG. 1 and FIG. 2.

As shown in FIG. 1 (a) or FIG. 1(b), the sealing member 7 has a flat plate shape, and a sealing surface 5a and a pressure receiving surface 5b are respectively formed on both surfaces of the sealing member 7. A projecting portion 13 (shown in an enlarged manner in FIG. 3(a)) is formed on the sealing surface 5a in a projecting manner in the direction opposite to the pressure receiving surface 5b, and a mirror finish is applied to the sealing surface 5a. The sealing member 7 is disposed in a connecting portion 12 of a wall member 11a or a pressurized container 11b in an inwardly projecting manner.

In FIG. 1(a) and FIG. 2(a), although not shown in the drawings, both ends of the wall member 11a, 11a are closed in order to maintain an inner pressure. Further, the pressurized container 11b shown in FIG. 1(b) and FIG. 2(b) has the hollow structure and hence, the sealing member 7 has an annular shape.

In the sealing member 7 having the above-mentioned structure, a pressure of a fluid which exists inside the wall member 11a or the inside the pressurized container 11b is applied to the pressure receiving surface 5d so that an action is generated where the sealing surface 5a of one sealing member 7 is pushed to the sealing surface 5a of the other sealing member 7. Accordingly, when the sealing members 7, 7 are used at the connecting portion 12 of the wall member 11a or the pressurized container 11b, a pressure of a fluid inside the wall member 11a or the inside the pressurized container 11b is applied to the sealing members 7, 7 in such a manner that the pressure sandwiches the sealing members 7, 7 from both sides and hence, an action is generated where the sealing surfaces 5a, 5a are pushed to each other.

Since a mirror finish is applied to the sealing surface 5a, a fluid minimally enters between the sealing surfaces 5a, 5a.

Further, the sealing member 7 is formed such that the sealing surface 5a projects in the direction opposite to the pressure receiving surface 5d and hence, even when the sealing surface 5a of the other sealing member 7 is not flat and is formed into a projection shape or a recessed shape, an action is generated where the sealing surfaces 5a, 5a are easily made to adhere to each other.

In this manner, according to the sealing member 7 of the present invention, sealing property at the connecting portion 12 of the wall members 11a or at the connecting portion 12 of the pressurized container 11b can be enhanced. Further, the sealing member 7 has the simple structure and hence, the sealing member 7 minimally causes a defect and, further, a manufacturing cost and an installation cost can be lowered. Accordingly, by applying the sealing member 7 of the present invention to the wall member 11a or the pressurized container 11b, a manufacturing cost can be lowered.

In this specification, a spaceship, a space suit, a rocket, an airplane, a ship, a submarine, a bathyscaphe or the like where the wall member 11a having the above-mentioned structure is used as a wall of fuselage or a compartment is referred to as “wall structure finished product”, and a boiler, a tower or a vessel, a heat exchanger, a tank or the like where the pressurized container 11b having the above-mentioned structure is used as a container body is referred to as “pressurized container finished product”. Further, in this specification, for example, a set of plant facilities for producing a product for a predetermined purpose which is constructed by organically combining towers or vessels, boilers, heat exchangers, vacuum equipment, hydraulic equipment, pumps, valves, measuring instrument, tanks and the like by pipes, electric wires and the like is particularly referred to as “plant”.

In the sealing members 7, 7, as a pressure of a fluid applied to the pressure receiving surfaces 5d, 5d is higher, the sealing property of the sealing surfaces 5a, 5a becomes higher. Accordingly, when an inner pressure P₁ is higher than an outer pressure P₂, as shown in FIG. 1(a) and FIG. 1(b), it is desirable that the sealing members 7, 7 are formed in a projecting manner toward a side where a pressure of a fluid is high, that is, toward the inside of the wall member 11a or the inside of the pressurized container 11b.

On the other hand, when an outer pressure P₂ is higher than an inner pressure P₁, as shown in FIG. 1(a) or FIG. 1(b), it is desirable that the sealing members 7 are formed in a projecting manner toward the outside of the wall member 11a or the outside of the pressurized container 11b (see FIG. 2(a) and FIG. 2(b)).

Due to such a structure, a pressure of a fluid existing outside the wall member 11a or the outside of the pressurized container 11b pushes the sealing members 7, 7 from both sides in a sandwiching manner so that the pressure of the fluid acts so as to increase a close contact force at the sealing surfaces 5a, 5a, whereby sealing property at the connecting portion 12 of the wall member 11a or the pressurized container 11b can be easily increased.

In FIG. 1(a) and FIG. 2(a), the sealing members 7 are provided orthogonal to the wall member 11a. However, it is not always necessary to adopt such a structure. For example, as shown in FIG. 3(a), it may be possible to adopt the structure where sealing members 7 are provided parallel to a wall member 11a. Further, the sealing members 7 may be provided such that the sealing members 7 make a desired angle except for 0 degree and 90 degrees with respect to the wall member 11a.

It may be also possible to adopt the structure where a sealing surface 5a is formed on a recessed portion 14 which is provided in an indented manner in the direction toward a pressure receiving surface 5d. Due to such a structure, a gasket 10a is held in the recessed portion 14. Accordingly, it is possible to increase close contact property of the sealing surface 5a by mounting the gasket 10a on the sealing surface 5a. A mirror finish applied to the sealing surface 5a may be omitted.

Further, as shown in FIG. 3(b), it may be also possible to adopt the structure where flanges 2 are formed on a wall member 11a in a projecting manner in a direction opposite to sealing members 7, and the flanges 2, 2 in a state where the flanges 2, 2 abut each other are fastened together using bolts 4a and nuts 4b.

Alternatively, as shown in FIG. 3(c), bolt holes may be formed in sealing members 7, and the sealing members 7, 7 may be fastened together by bolts 4a and nuts 4b in a state where the sealing members 7, 7 abut each other.

In this manner, by fastening the flanges 2, 2 or the sealing members 7, 7 respectively using the bolts 4a and the nuts 4b, the sealing members 7, 7 are constrained such that the sealing members 7, 7 are not displaced from each other in a direction parallel to sealing surfaces 5a and hence, sealing property at the sealing surfaces 5a is increased.

Further, as shown in FIG. 4, in the constitution shown in FIG. 1(b), the sealing members 7 may be formed by forming annular grooves 6 on inner wall surfaces 11c of the pressurized containers 11b over the whole circumference. Further, in FIG. 4, the structure is adopted where the flanges 2, 2 are fastened together using the bolts 4a and the nuts 4b. An action generated by fastening the flanges 2, 2 using the bolts 4a and the nuts 4b is substantially equal to the action generated in the case of the above-mentioned wall members 11a.

In this case, the sealing members 7 can be easily formed at the connecting portion 12. A pressure of a fluid which enters the inside of the annular groove 6 is applied to the pressure receiving surface 5d of the sealing member 7, and the pressure acts so as to increase a close contact force on the sealing surfaces 5a and hence, sufficient sealing property can be acquired at the connecting portion 12. That is, according to the above-mentioned structure, it is possible to manufacture the pressurized container 11b having excellent sealing property at the connecting portion 12 at a low cost.

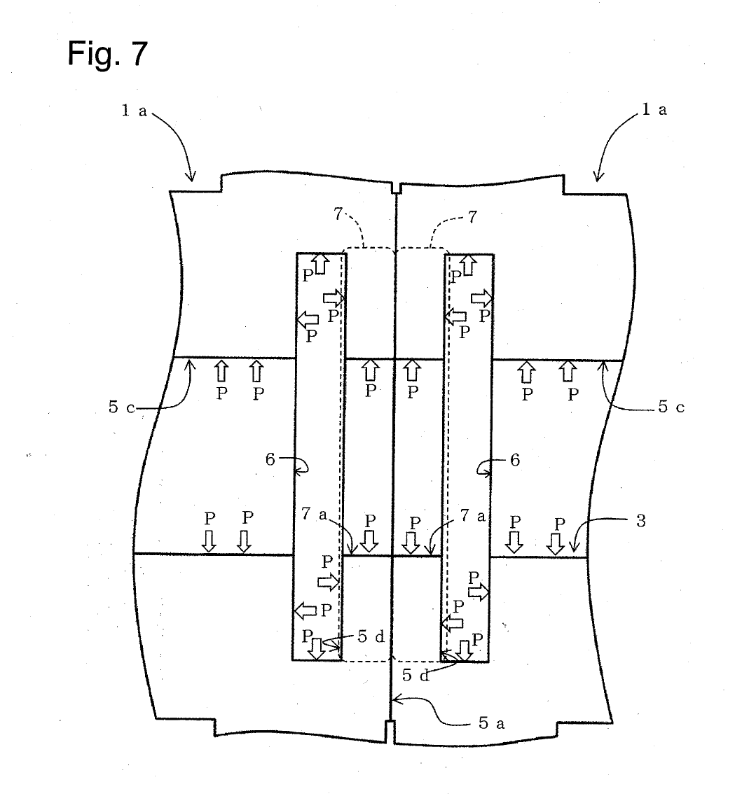

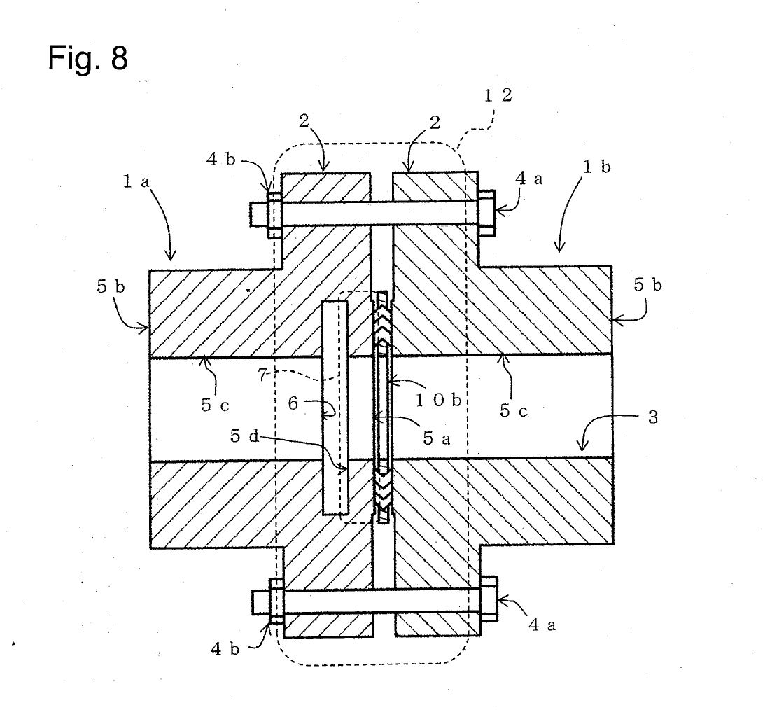

A depth of the annular groove 6 is not limited to the case shown in FIG. 4. For example, the annular groove 6 may exceed a plate thickness portion of an inner wall surface 11c so that a portion of the annular groove 6 may be formed inside the flange 2. The same goes for the structures shown in FIG. 7, FIG. 8 and FIG. 10 to FIG. 17 described later.

In the examples shown in FIG. 1 to FIG. 3, the sealing member 7 may be formed by applying working to an angle member, a T-shaped member, a square member or the like made of the same material as the wall member 11a or the pressurized container 11b, and the sealing member 7 may be integrally formed with the wall member 11a or the pressurized container 11b by a joining method suitable for the material. Further, the pressurized container 11b shown in FIG. 4 has the structure where a groove is formed on an inner periphery of a generally standardized flange by cutting and hence, it is sufficient that a member manufactured in accordance with designing and working steps of the flange is integrally formed with the pressurized container 11b by joining. However, the method of integrally forming the sealing member 7 with the wall member 11a or the pressurized container 11b is not limited to these methods, and the sealing member 7 may be integrally formed with the wall member 11a or the pressurized container 11b by casting, injection molding or the like.

Further, the pressurized containers 11b shown in FIG. 1, FIG. 2 and FIG. 4 may not be limited to a circular cylindrical shape, and may be formed into an angular cylindrical shape or the like.

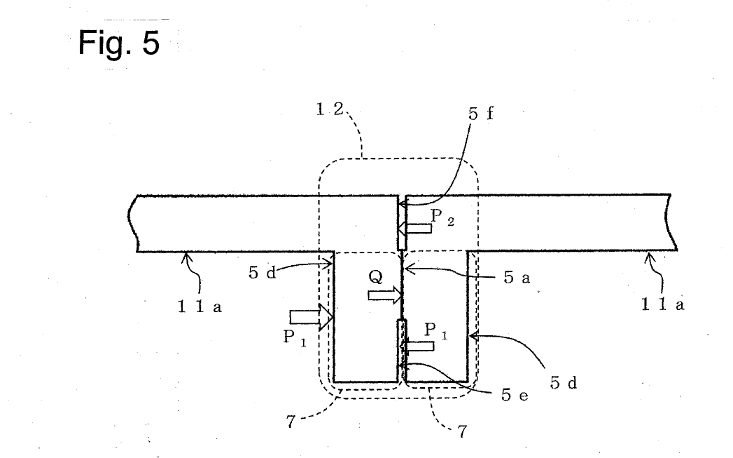

Hereinafter, with respect to the sealing member 7, the influence which an area of the pressure receiving surface 5d and an area of the sealing surface 5a exert on sealing property is described by reference to FIG. 5.

FIG. 5 is a schematic view showing a state where the sealing members 7 of this embodiment are mounted on the connecting portion 12 of the wall member 11a. The state corresponds to the case where the sealing members 7 are formed such that the area of the sealing surface 5a is smaller than the area of the pressure receiving surface 5d in FIG. 1(a). To avoid that FIG. 5 becomes cumbersome, only pressures applied to the sealing member 7 of the wall member 11a on one side are shown in FIG. 5.

Although the description is made by taking the joint structure for a wall member as an example here, the description made hereinafter is also applicable to the joint structure for a pressurized container or the joint structure for pipes described later in the same manner.

In a pressurized container used in a state where an inner pressure P₁ is higher than an outer pressure P₂, assuming areas of surfaces which are orthogonal to an open/close direction and to which the inner pressure P₁ and the outer pressure P₂ are applied respectively as Sₐ and S and a fastening force generated by bolts 4a and nuts 4b as W, the relationship W+P₂S>P₁Sₐ is established. However, when the outer pressure P₂ acts in a direction that the pressurized container is closed, the area of the surface to which the outer pressure P₂ is applied is S, and this S does not include an area S₄ of a pressure receiving surface 5f described later. Further, when the relationship P₂5>P₁Sₐ is established, the fastening force W generated by the bolts 4a and the nuts 4b may be omitted.

FIG. 5 shows the case where the inner pressure P₁ is higher than the outer pressure P₂ and sealing members 7 are formed in a projecting manner toward the inside. However, when the outer pressure P₂ is higher than the inner pressure P₁ and the sealing members 7 are formed in a projecting manner toward the outside, the case may be treated by exchanging P₁ and P₂ in a following formula (1).

In FIG. 5, a pressure applied to a sealing surface 5a of the mating sealing member 7 from a sealing surface 5a of one sealing member 7 due to actions of the inner pressure P₁ and the outer pressure P₂ is assumed as Q. Also surfaces which are disposed on the same side as the sealing surface 5a and which receives the inner pressure P₁ and the outer pressure P₂ respectively are assumed as pressure receiving surfaces 5e, 5f.

In this case, the pressure Q can be expressed as follows using an area S₁ of the sealing surface 5a and areas S₂ to S₄ of the pressure receiving surfaces 5d to 5f.

Q=P₁(S₂−S₃)/S₁−P₂S₄/S₁ (1)

(In the formula, S₁<S₂)

It is understood from the formula (1) that. when S₁ and S₃ are decreased while setting the inner pressure P₁ and the outer pressure P₂ at fixed values, Q is increased. However, the decrease of S₁ and S₃ means that the area of the sealing surface 5a and the area of the pressure receiving surface 5e are decreased, and the area S₄ of the pressure receiving surface 5f is increased. Accordingly, when the difference between the inner pressure P₁ and the outer pressure P₂ is small, the second term on a right side in the formula (1) largely influences Q. However, when the difference between the inner pressure P₁ and the outer pressure P₂ is large to an extent that the influence of the second term on the right side of the formula (1) can be ignored, it is desirable that the area S₃ of the pressure receiving surface 5e is made as small as possible and the area S₁ of the sealing surface 5a is made small by providing the sealing surface 5a in the vicinity of a distal end of the sealing member 7.

With the use of the sealing member 7 having such a structure, an action is generated where the sealing surface 5a of one member is pushed to the sealing surface 5a of the mating member by the pressure Q larger than the inner pressure P₁ applied to the pressure receiving surface 5d. In this case, a close contact force of the sealing surface 5a is increased, and hence the above-mentioned advantageous effect of ensuring sufficient sealing property at the connecting portion 12 can be further enhanced.

Also with respect to a wall structure finished product and a pressurized container finished product which are provided with the above-mentioned joint structure of the wall member 11a and the joint structure of the pressurized container 11b respectively, the above-mentioned manner of operation and the advantageous effects at the joint structure of the wall member 11a and the joint structure of the pressurized container 11b can be acquired in the same manner. Also in a plant provided with the sealing member 7, the above-mentioned manner of operation and advantageous effects of the sealing member 7 can be acquired in the same manner.

In this embodiment, a mirror finish is exemplified as a method of increasing close contact property of the sealing surface 5a. However, the method of increasing close contact property of the sealing surface 5a is not limited to such a mirror finish, and surface accuracy may be increased by applying plating to the sealing surface 5a. Further, by applying a material having the lower surface hardness than surrounding members to the sealing surface 5a by coating, affinity between the sealing surfaces may be improved. The above-mentioned manner of operation and advantageous effects can be also acquired in the same manner by such methods.

Further, a method which uses a reamer bolt or a knock pin may be adopted for preventing the positional displacement between the sealing surfaces.

As described previously, in the sealing member 7 of the present invention, the sealing surface 5a is required to possess high surface accuracy. Accordingly, along with spreading of the present invention, a demand for a technique which works the sealing surface 5a with high accuracy is increased, thus accelerating the development of nanotechnology.

### Embodiment 2

The description is made with respect to a case where the above-mentioned sealing members are used in a pipe joint mounted on a connecting portion of a part such as a valve or a pipe in piping used for transporting a fluid such as a liquid or a gas and the like.

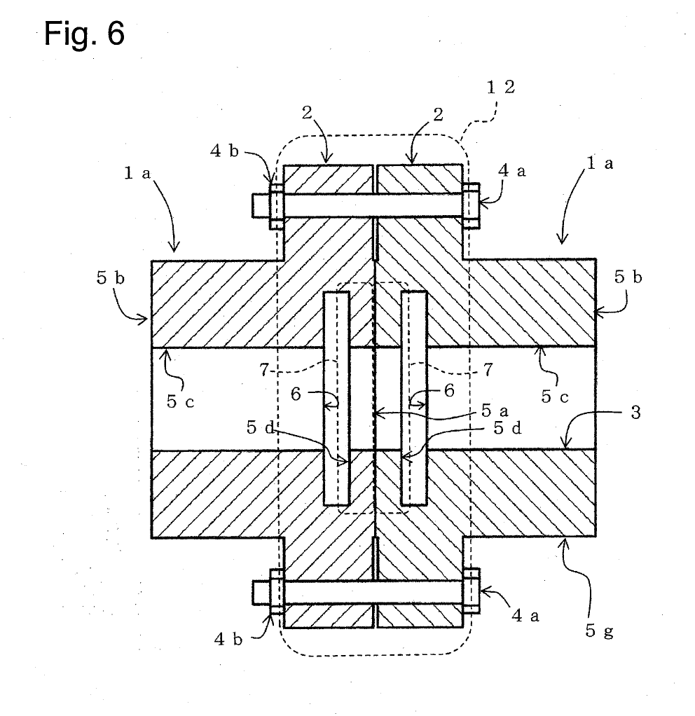

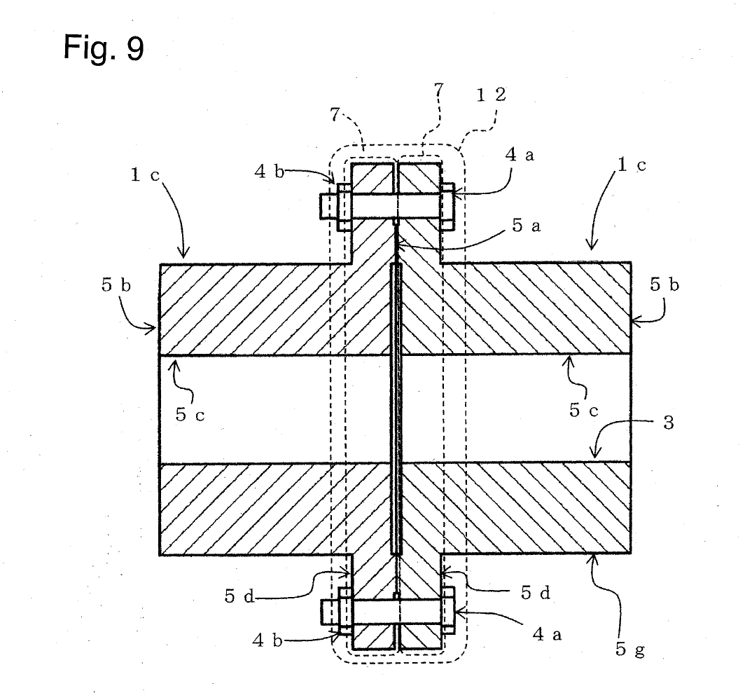

FIG. 6 is a cross-sectional view showing a state where sealing members 7 are used in a pipe joint 1a. FIG. 7 is a view for explaining the manner of operation of the sealing members 7. FIG. 8 and FIG. 9 are views showing modifications of the pipe joint shown in FIG. 6.

FIG. 6 to FIG. 9 are cross-sectional views taken along a plane which includes a center axis of a pipe. FIG. 7 corresponds to a partially enlarged view of FIG. 6. In FIG. 6, only the pipe joint is shown in cross-section. In FIG. 7, hatching which indicates a cross section is omitted also with respect to the pipe joint.

As shown in FIG. 6, the pipe joint la is made of metal. One end surface of the pipe joint 1a constitutes a sealing surface 5a, and the other end surface of the pipe joint 1a constitutes a connecting surface 5b which is connected to a wall member of another pipe or the like. A mirror finish is applied to the sealing surface 5a. A material for forming the pipe joint 1a is not limited to metal, and the pipe joint 1a may be formed using plastic.

In the vicinity of a connecting portion 12, a flange 2 having a donut plate shape and having a plurality of bolt holes in a circumferential direction is formed on an outer peripheral surface 5g of the pipe joint la in an erected manner. That is, there is provided the structure where the pipe joints 1a, 1a are connected to each other by fastening the flanges 2, 2 using bolts 4a and nuts 4b in a state where the sealing surfaces 5a, 5a abut each other.

An annular groove 6 is formed on an inner peripheral surface 5c of the pipe joint 1a over the whole circumference in the vicinity of the sealing surface 5a of the pipe joint 1a such that a sealing member 7 having a circular annular plate shape is formed. That is, a side surface of the sealing member 7 which faces the annular groove 6 constitutes a pressure receiving surface 5d.

In the pipe joints 1a, 1a in a state where the flanges 2, 2 are fastened to each other by the bolts 4a and the nuts 4b, a fastening force of the bolts 4a acts as a force for bringing the sealing surfaces 5a, 5a into close contact to each other, and at the same time, for maintaining the relative positional relationship.

Further, as shown in FIG. 7, a fluid which flows into the inside of a flow passage 3 also enters the inside of the annular groove 6. Accordingly, a pressure of the fluid (hereinafter referred to as inner pressure P) is applied not only to the inner peripheral surface 5c but also to the pressure receiving surface 5d. That is, the inner pressure P acts so as to increase a close contact force between the sealing members 7, 7 by pushing the sealing members 7, 7 from both sides in a sandwiching manner.

Accordingly, sealing property of the sealing surfaces 5a, 5a is increased.

The sealing member 7 is formed such that an inner peripheral surface 7a of the sealing member 7 becomes coplanar with the inner peripheral surface 5c of the pipe joint 1a, and hence there is no possibility that the sealing member 7 becomes an obstacle against a fluid which flows through the inside of the flow passage 3 formed in the pipe joint 1a.

In this manner, with the use of the pipe joint 1a provided with the sealing member 7, a close contact force of the sealing surface 5a is increased by making use of a pressure of a fluid which flows in the inside of the flow passage 3 and hence, sufficient sealing property can be acquired in the connecting portion 12 of the pipe or the like. Further, the sealing member 7 is formed as a part of the pipe joint 1a, and hence the structure is simple whereby a defect minimally occurs and, at the same time, the pipe joint 1a can be manufactured at a low cost.

Further, time and efforts for selecting a gasket can be omitted. Still further, even when a mating member is an existing member, the sealing member is applicable to the pipe joint, and hence general-use property of the sealing member 7 is high.

The pipe joint 1a having the above-mentioned structure can be used in a pipe which connects pumps, compressors, valves, measuring instrument, boilers, towers and vessels, heat exchangers, tanks and the like.

As shown in FIG. 8, a pipe joint 1b in which neither the annular groove 6 nor the sealing member 7 is formed may be also connected to the pipe joint 1a. Also in such a case, a pressure of a fluid which flows through the inside of the flow passage 3 is applied to the pressure receiving surface 5d of the sealing member 7 provided to the pipe joint 1a, and hence a close contact force of the sealing surfaces 5a, 5a is increased, whereby, sufficient sealing property can be ensured in a connecting portion 12 between the pipe joint 1a and the pipe joint 1b.

The pipe joints 1a, 1b shown in FIG. 8 have the structure where a spiral gasket 10b is disposed on the sealing surface 5a in place of applying a mirror finish to the sealing surface 5a.

The pipe joint 1a of this embodiment is particularly effective when applied to a pipe which is used in a state where a pressure of a fluid in the inside of the pipe is higher than a pressure of a fluid outside the pipe. However, it is desirable to use a pipe joint 1c show in FIG. 9 for a pipe which is used in a state where a pressure of a fluid outside the pipe is higher than a pressure of a fluid inside the pipe.

To explain more specifically, as shown in FIG. 9, the pipe joint 1c has, compared to the pipe joint 1a, the structure where a sealing member 7 is provided to an outer peripheral surface 5g in an erected manner in the vicinity of a connecting portion 12, and the sealing members 7 are fastened to each other by bolts 4a and nuts 4b in place of forming the flanges 2 and the annular grooves 6.

The pipe joint 1c having such a structure can effectively acquire the substantially same manner of operation and advantageous effects as the pipe joint la when a pressure of a fluid outside a pipe is higher than a pressure of a fluid in the inside of the pipe. That is, the pipe joint 1c can be used in a pipe which is used for transporting seabed underground resources such as petroleum, a natural gas, and methane hydrate to the ground, a pipe used with the inside thereof in a vacuum state or the like.

### Embodiment 3

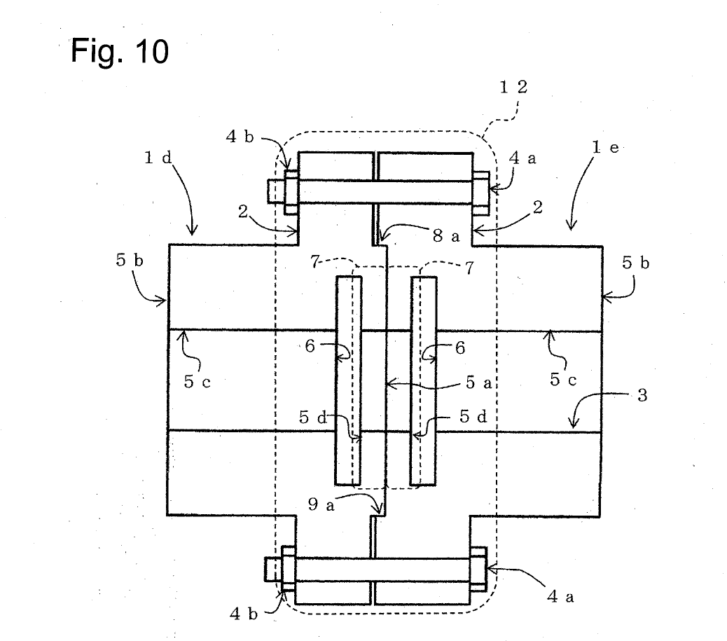

Another embodiment of the joint structure of a pipe provided with sealing members 7 is described using FIG. 10.

FIG. 10 is a cross-sectional view showing a state where the sealing members 7 are used in pipe joints 1d, 1e. FIG. 10 is a cross-sectional view taken along a plane which includes a center axis of the pipe. Constitutional elements which are equal to the constitutional elements shown in FIG. 6 to FIG. 9 are given the same symbols and the description of these constitutional elements is omitted. Further, in FIG. 10, hatching which indicates a cross section is omitted with respect to the pipe joint. Further, in this specification, constitutional elements which are connected by pipes provided with the joint structure for a pipe described hereinafter and the pipes are referred to as a pipe unit.

As shown in FIG. 10, in the pipe joint 1d, a sealing surface 5a is formed on a circular cylindrical projecting portion 8a formed in a projecting manner in a direction opposite to a pressure receiving surface 5d in the pipe joint 1a of the embodiment 2, and a recessed portion 9a which is engageable with the projecting portion 8a is formed on the pipe joint 1e. Due to such a structure, the projecting portion 8a and the recessed portion 9a have a function of constraining the pipe joints 1d, 1e so as to prevent the relative movement in a direction parallel to the sealing surfaces 5a when the pipe joints 1d, 1e are connected to each other.

The pipe unit provided with the above-mentioned joint structure for a pipe can also acquire the above-mentioned manner of operation and advantageous effects in the same manner.

Although the projecting portion 8a is formed into a circular cylindrical shape in this embodiment, the projecting portion 8a is not limited to such a shape, and for example, may be formed into an angular cylindrical shape.

In the pipe joint 1a of the embodiment 2, when vibrations or the like are applied to the pipe in a state shown in FIG. 6, the sealing members 7, 7 receive a shearing force, and hence there is a possibility that the sealing members 7, 7 are slightly displaced in the direction parallel to the sealing surfaces 5a. When the sealing members 7, 7 are displaced so that the sealing surfaces 5a are brought into contact with a fluid, an inner pressure P acts so as to separate the sealing members 7, 7 from each other by pulling. As a result, sealing property of the sealing surfaces 5a, 5a is lowered.

To the contrary, in the pipe joints 1d, 1e having the above-mentioned structure, as shown in FIG. 10, the projecting portion 8a engages with the recessed portion 9a. Accordingly, even when vibrations or the like are applied to a pipe so that the sealing members 7, 7 receive a shearing force, the sealing members 7, 7 are minimally displaced in the direction parallel to the sealing surfaces 5a. Accordingly, lowering of sealing property in the connecting portion 12 can be prevented.

### Embodiment 4

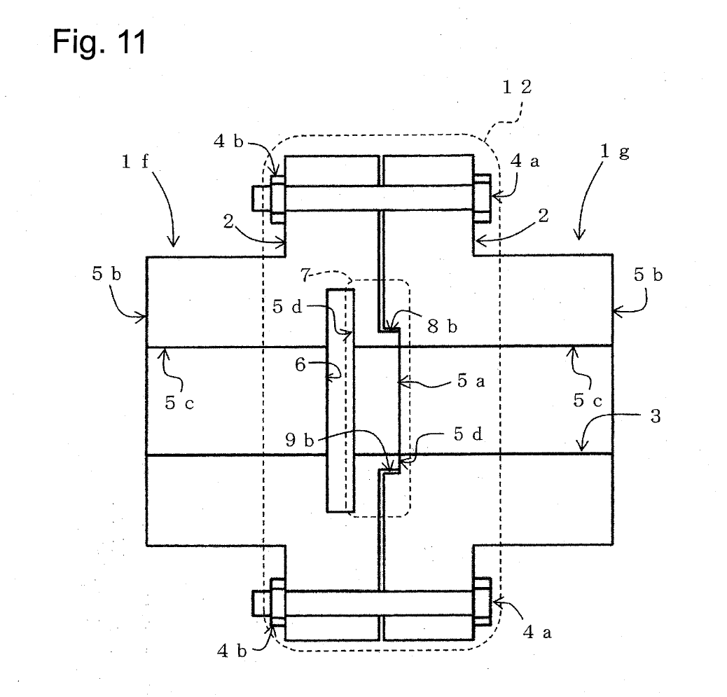

Another embodiment of the joint structure of a pipe provided with sealing members 7 is further described using FIG. 11. As described previously, the description made hereinafter is also applicable to a pressurized container provided with sealing members 7 in the same manner. When the pressurized container is used in a state where an inner pressure P₁ is higher than an outer pressure P₂, as described previously, assuming areas of surfaces which are orthogonal to an open/close direction and to which the inner pressure P₁ and the outer pressure P₂ are applied respectively as Sₐ and S and a fastening force generated by bolts 4a and nuts 4b as W, the relationship W+P₂S>P₁Sₐ is established. However, when the outer pressure P₂ acts in a direction that the pressurized container is closed, the area of the surface to which the outer pressure P₂ is applied is S, and this S does not include the area S₄ of the previously-mentioned pressure receiving surface 5f. Further, when the relationship P₂S>P₁Sₐ is established, the fastening force W generated by the bolts 4a and the nuts 4b may be omitted.

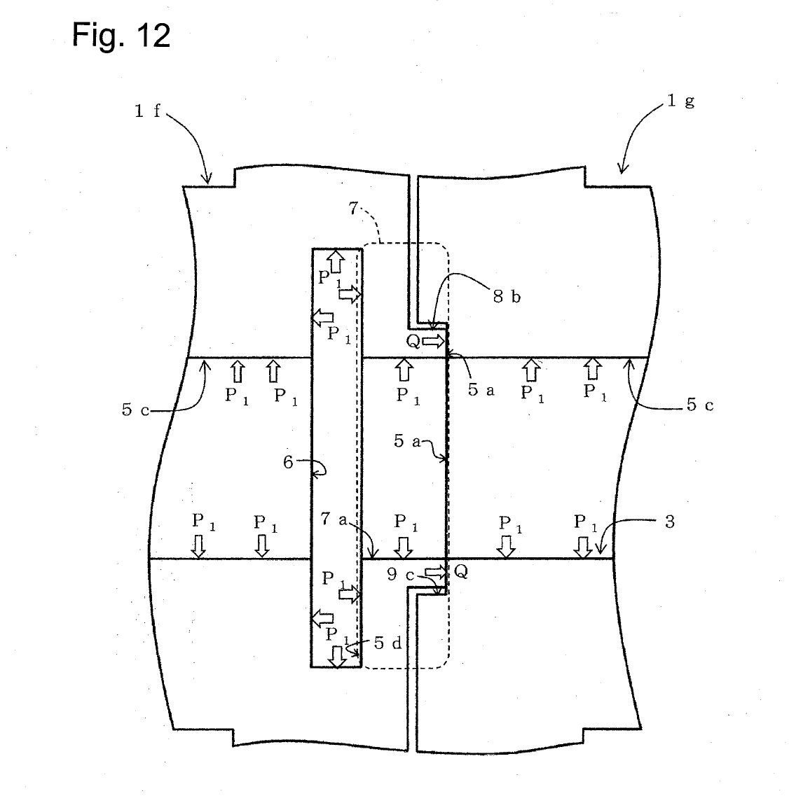

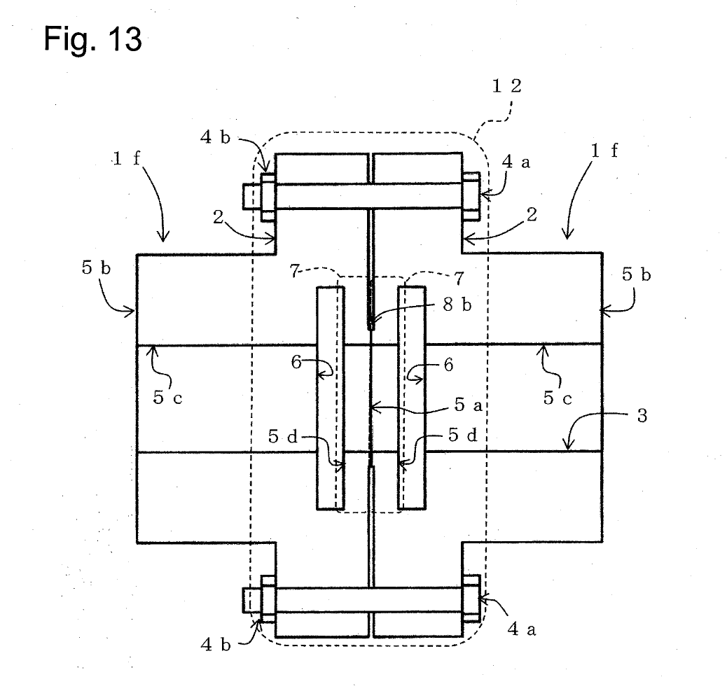

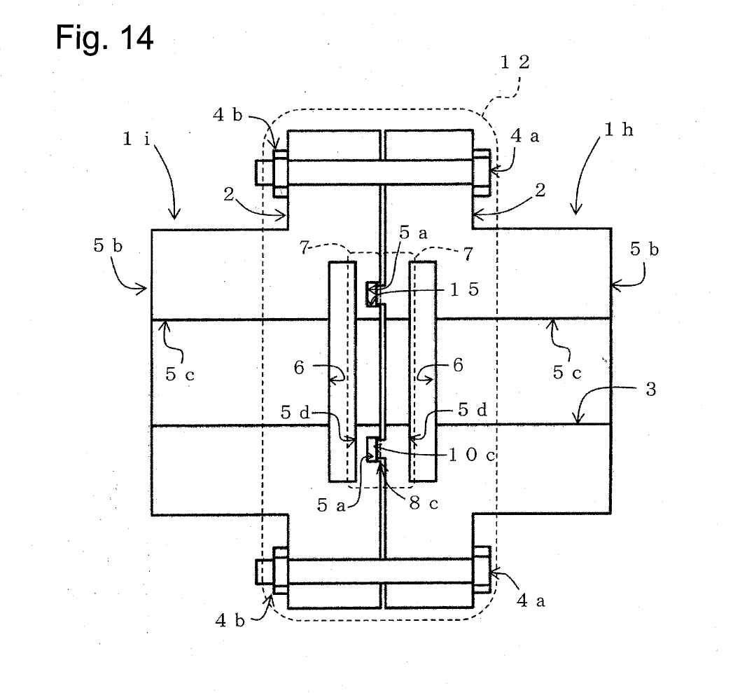

FIG. 11 is a longitudinal cross-sectional view showing a state where the sealing members 7 are used in pipe joints 1f, 1g, and FIG. 12 is a view for explaining the manner of operation of the sealing members 7. Further, FIG. 13 and FIG. 14 are views showing modifications of the pipe joints shown in FIG. 11.

FIG. 11 to FIG. 14 are cross-sectional views taken along a plane which includes a center axis of the pipe. FIG. 12 corresponds to a partially enlarged view of FIG. 11. Constitutional elements which are equal to the constitutional elements shown in FIG. 6 to FIG. 10 are given the same symbols and the description of these constitutional elements is omitted. Further, in FIG. 11 to FIG. 14, hatching which indicates a cross section is omitted with respect to the pipe joint.

As shown in FIG. 11, compared to the pipe joint 1d of the embodiment 3, the pipe joint 1f has the structure where a projecting portion 8b is formed in place of the projecting portion 8a, and the projecting portion 8b is formed such that an area of a sealing surface 5a is smaller than an area of a pressure receiving surface 5d.

Further, compared to the flange joint 1e, the flange joint 1g has the structure where the annular groove 6 is not formed in the flange joint 1g, and a recessed portion 9b in which the projecting portion 8b is loosely fitted is formed in place of the recessed portion 9a.

In FIG. 12, a pressure Q which the sealing surface 5a of the pipe joint 1g receives from the sealing surface 5a of the pipe joint if due to an action of an inner pressure P₁ can be expressed as follows using an area S₁ of the sealing surface 5a and an area S₂ of the pressure receiving surface 5d of the pipe joint 1f when the inner pressure P₁ is sufficiently large compared to an outer pressure P₂ such that the second term of the right side in the above-mentioned formula (1) can be ignored.

Q=P₁S₂/S₁ (2)

(In the formula, S₁<S₂)

The relationship Q>P₁ is established from the formula (2). That is, the pressure Q which the sealing surface 5a of the pipe joint 1g receives from the sealing surface 5a of the pipe joint 1f due to an action of an inner pressure P₁ becomes larger than the inner pressure P₁.

In this manner, in the pipe joint 1f having the above-mentioned structure, an action is generated such that a pressure larger than an inner pressure P₁ applied to the pressure receiving surface 5d is applied to the sealing surface 5a of the pipe joint 1g from the sealing surface 5a. Accordingly, by increasing a close contact force of the sealing surface 5a by making use of a pressure of a fluid in the inside of a flow passage 3, the advantageous effects described in conjunction with the embodiment 1 that sufficient sealing property can be ensured in the connecting portion 12 can be further increased.

In this embodiment, the description has been made with respect to the case where the pipe joint 1g in which the annular groove 6 is not formed and the flange joint 1f in which the annular groove 6 is formed are connected to each other. However, for example, as shown in FIG. 13, it is also possible to connect the pipe joints 1f, 1f to each other.

Also in this case, the above-mentioned manner of operation and advantageous effects described in conjunction with this embodiment can be acquired in the same manner.

Further, as shown in FIG. 14, pipe joints 1h, 1i can be also used in place of the pipe joints 1f, 1g.

Compared to the pipe joint 1f, the pipe joint 1h has the structure where a sealing surface 5a is formed on a circular annular projecting portion 8c in place of the projecting portion 8b such that an area of the sealing surface 5a is set smaller than an area of a pressure receiving surface 5d.

Further, compared to the pipe joint 1h, the pipe joint 1i has the structure where an annular groove 15 into which the projecting portion 8c is loosely fitted is formed in place of the projecting portion 8c, and a circular annular gasket 10c is disposed in the inside of the annular groove 15. That is, in the pipe joint 1i, a bottom surface of the annular groove 15 constitutes the sealing surface 5a.

Even when the pipe joints 1h, 1i having such a structure are connected to each other, the above-mentioned manner of operation and advantageous effects can be acquired in the same manner. Since the gasket 10c is interposed between the sealing surface 5a of the pipe joint 1h and the sealing surface 5a of the pipe joint 1i, it is not always necessary to apply a mirror finish to these sealing surfaces 5a, 5a.

Further, when the annular circular gasket 10c is not disposed in the inside of the annular groove 15, a surface on which the annular groove 15 is formed (a surface which is brought into contact with the pipe joint 1h) forms a sealing surface. That is, a sealing surface is formed on a side close to the flow passage 3 and a side away from the flow passage 3 respectively with the annular groove 15 sandwiched therebetween. Due to such a structure, as described later, an annular space portion is formed between facing surfaces of the sealing members 7, 7 by the annular groove 15.

### Embodiment 5

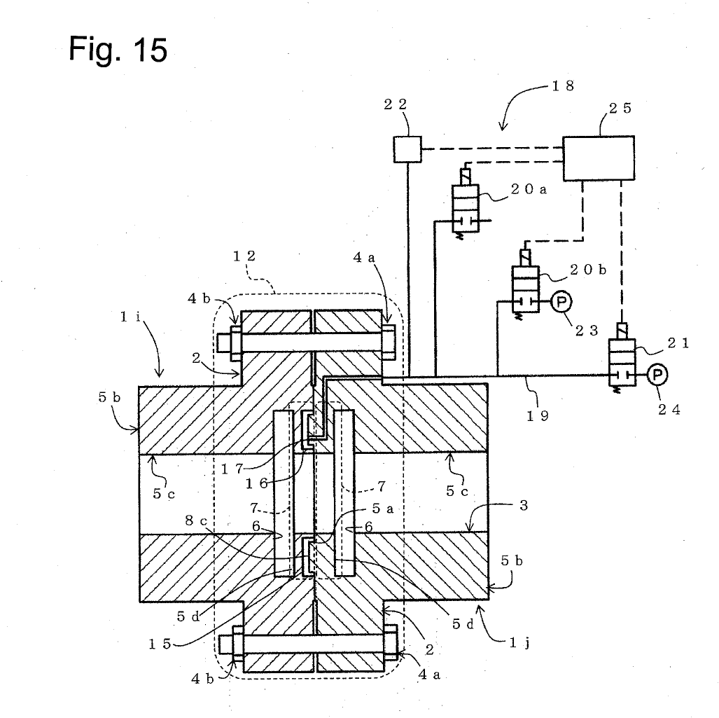

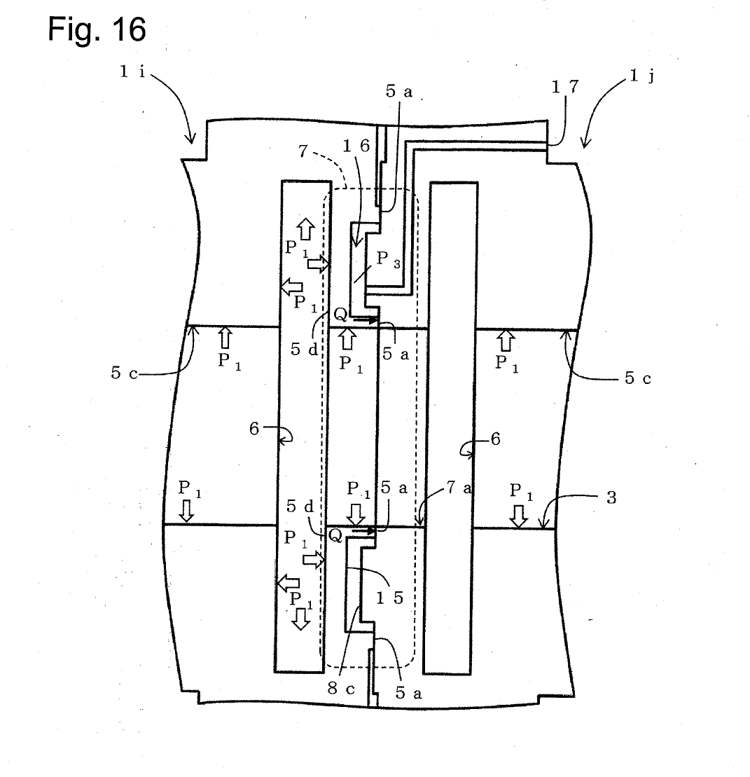

Another embodiment of the joint structure of a pipe provided with sealing members 7 is described using FIG. 15 and FIG. 16.

FIG. 15 is a longitudinal cross-sectional view showing a state where the sealing members 7 are used in the pipe joints 1i, 1j, and FIG. 16 is a view for explaining the manner of operation of the sealing members 7. In FIG. 16, hatching which indicates a cross section is omitted with respect to the pipe joints 1i, 1j. Constitutional elements which are equal to the constitutional elements shown in FIG. 11 to FIG. 14 are given the same symbols and the description of these constitutional elements is omitted.

As shown in FIG. 15, compared to the pipe joints 1h, 1i shown in FIG. 14, the pipe joint 1j used in the joint structure for a pipe according to the present invention is characterized in that an annular space portion 16 is formed by an annular groove 15 and a projecting portion 8c between facing surfaces of the sealing members 7, 7, and an air supply/discharge hole 17 is formed in the pipe joint 1h so as to adjust an inner pressure of the annular space portion 16, and air supply/discharge means 18 is connected to the air supply/discharge hole 17. Further, the sealing member 7 is formed such that an area of a sealing surface 5a is set smaller than an area of a pressure receiving surface 5d.

One open end of the air supply/discharge hole 17 is formed on a surface of the projecting portion 8c, and the other open end of the air supply/discharge hole 17 is formed on a surface of the flange 2. Differing from the case shown in FIG. 14, a gasket 10c is not disposed in the inside of the annular groove 15 in the pipe joint 1i.

The air supply/discharge means 18 is constituted of: an air supply/discharge pipe 19 which has one end thereof connected to the air supply/discharge hole 17; an open electromagnetic valve 20a and an air discharge electromagnetic valve 20b which have an output side thereof connected to the other end of the air supply/discharge pipe 18; an air supply electromagnetic valve 21 which has an input side thereof connected to the other end of the air supply/discharge pipe 19; a pressure sensor 22; and a vacuum pump 23 and an air supply pump 24; and a control part 25.

The output side of the open electromagnetic valve 20a opens in the atmosphere, and the vacuum pump 23 and the air supply pump 24 are connected to the output side of the air discharge electromagnetic valve 20b and the input side of the air supply electromagnetic valve 21, respectively. That is, the pressure sensor 22 functions as pressure detection means for detecting an inner pressure of the annular space portion 16 through the air supply/discharge hole 17 and the air supply/discharge pipe 19, and a detection value by the pressure sensor 22 is transmitted to the control part 25. On the basis of the detection value, the control part 25 transmits an open signal or a close signal to the open electromagnetic valve 20a, the air discharge electromagnetic valve 20b, and the air supply electromagnetic valve 21, respectively, and transmits an operation signal or a stop signal to the vacuum pump 23 and the air supply pump 24, respectively.

In the air supply/discharge means 18 having such a constitution, in response to a close signal and an open signal from the control part 25, the open electromagnetic valve 20a and the air supply electromagnetic valve 21 are closed, and at the same time, the air discharge electromagnetic valve 20b is opened. Then, when the vacuum pump 23 starts the operation in response to an operation signal from the control part 25, a gas in the annular space portion 16 is forcibly discharged to the outside of the pipe joint 1j through the air supply/discharge hole 17 and the air supply/discharge pipe 19. When a detection value of the pressure sensor 22 reaches a predetermined value, the vacuum pump 23 is stopped in response to a stop signal from the control part 25, and the air discharge electromagnetic valve 20b is closed in response to a close signal. Due to such an operation, the pressure in the annular space portion 16 is reduced to a predetermined pressure, and hence a close contact force of the sealing surface 5a is increased.

On the other hand, when the open electromagnetic valve 20a is opened in response to an open signal from the control part 25, air outside the pipe joint 1j flows into the annular space portion 16 through the air supply/discharge hole 17 and the air supply/discharge pipe 19. As a result, a pressure in the annular space portion 16 becomes equal to the atmospheric pressure, and hence a close contact force of the sealing surface 5a is decreased. Then, in response to a close signal and an open signal from the control part 25, the open electromagnetic valve 20a is closed, and at the same time, the air supply electromagnetic valve 21 is opened. Then, when the air supply pump 24 starts an operation in response to an operation signal from the control part 25, air outside the pipe joint 1j is forcibly supplied to the inside of the annular space portion 16 through the air supply/discharge hole 17 and the air supply/discharge pipe 19. Due to such an operation, the pressure in the annular space portion 16 becomes higher than the atmospheric pressure, and hence a close contact force of the sealing surface 5a is further decreased.

In the joint structure of a pipe according to the present invention, the presence or the non-presence of leakage of a fluid from the sealing surface 5a is detected by detecting an inner pressure of the annular space portion 16 using the pressure sensor 22. In this manner, according to the present invention, an abnormal state that a fluid leaks is readily detected so that the occurrence of an accident can be prevented in advance.

An action of an inner pressure in the annular space portion 16 is described hereinafter using FIG. 16.

In FIG. 16, assuming an area of an inner surface 15a of the annular groove 15 (a surface parallel to a pressure receiving surface 5d of the sealing member 7) as S₆ and an inner pressure in the annular space portion 16 as P₃, a pressure Q which the sealing surface 5a of the pipe joint 1j receives from the sealing surface 5a of the pipe joint 1i due to an action of an inner pressure P₁ is expressed as follows using an area S₁ of the sealing surface 5a and an area S₂ of the pressure receiving surface 5d. In FIG. 16, the sealing surface 5a is formed at two places sandwiching the annular groove 15, that is, the place on a side close to the flow passage 3 and the place on a side away from the flow passage 3. In this manner, when a plurality of sealing surfaces 5a exist, the total of areas of all sealing surfaces 5a become the area S₁.

Q=(P₁S₂−P₃ S₆)/S₁ (3)

(In the formula, S₁<S₆<S₂)

From the formula (3), when the relationship P₁<P₃ is established, the relationship Q>0 is always established. That is, when the pressure in the annular space portion 16 is reduced by the air supply/discharge means 18 such that an inner pressure P₃ becomes lower than an inner pressure P₁, regardless of the relationship between the inner pressure P₁ and an outer pressure P₂ in magnitude, as the inner pressure P₃ is lower, the pressure Q becomes higher, thus generating an action that a close contact force between the sealing surface 5a of the pipe joint 1j and the sealing surface 5a of the pipe joint 1i is increased. When the inner pressure P₃ is sufficiently small compared to the inner pressure P₁ to an extent that the inner pressure P₃ can be ignored, the pressure Q which the sealing surface 5a of the pipe joint 1j receives from the sealing surface 5a of the pipe joint 1i becomes larger than the inner pressure P₁ due to an action of the inner pressure P₁. On the other hand, when a gas is supplied to the annular space portion 16 by the air supply/discharge means 18 so that an inner pressure P₃ is increased, an action is generated so as to decrease a close contact force between the sealing surface 5a of the pipe joint 1j and the sealing surface 5a of the pipe joint 1i.

That is, with the use of the pipe joints 1i, 1j in the connecting portions of the pipes, a close contact force between the sealing surfaces 5a, 5a can be increased by making use of a pressure of a fluid, whereby sufficient sealing property can be ensured. Particularly, when it is necessary to dismantle a pipe in operations such as maintenance and checking, a close contact force can be decreased by increasing an inner pressure of the annular space portion 16, and hence the connecting portions of the pipe can be easily separated from each other.

### Embodiment 6

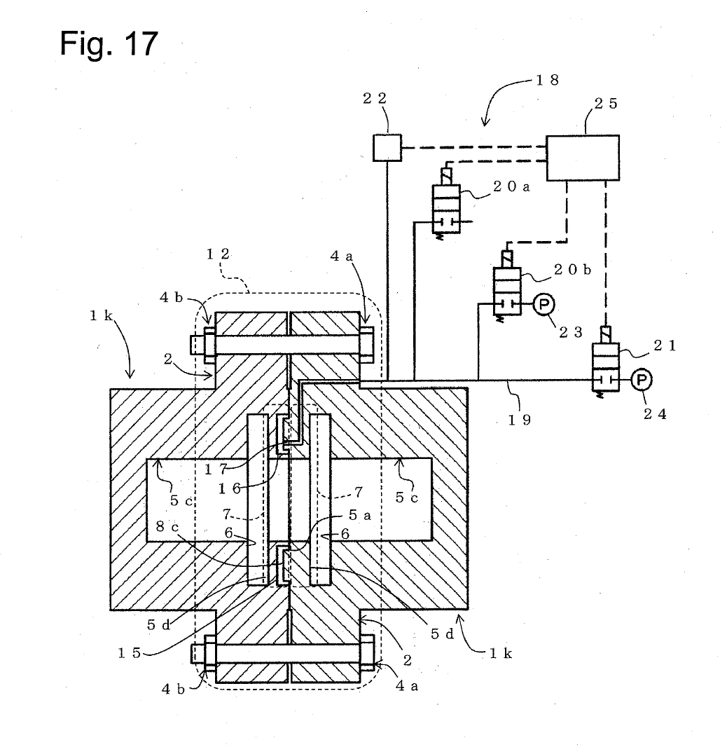

An embodiment of a pressurized container provided with sealing members 7 is described using FIG. 17. FIG. 17 is a longitudinal cross-sectional view showing a state where the sealing members 7 are used in a connecting portion 12 of a pressurized container 1k. Constitutional elements which are equal to the constitutional elements shown in FIG. 4 and FIG. 15 are given the same symbols and the description of these constitutional elements is omitted.

As shown in FIG. 17, the invention according to the embodiment 5 is applied to the pressurized container 11b which is already described, using FIG. 4, thereby obtaining the pressurized container 1k. Accordingly, such a pressurized container can acquire the substantially same manner of operation and advantageous effects as the invention according to the embodiment 5.

### Embodiment 7

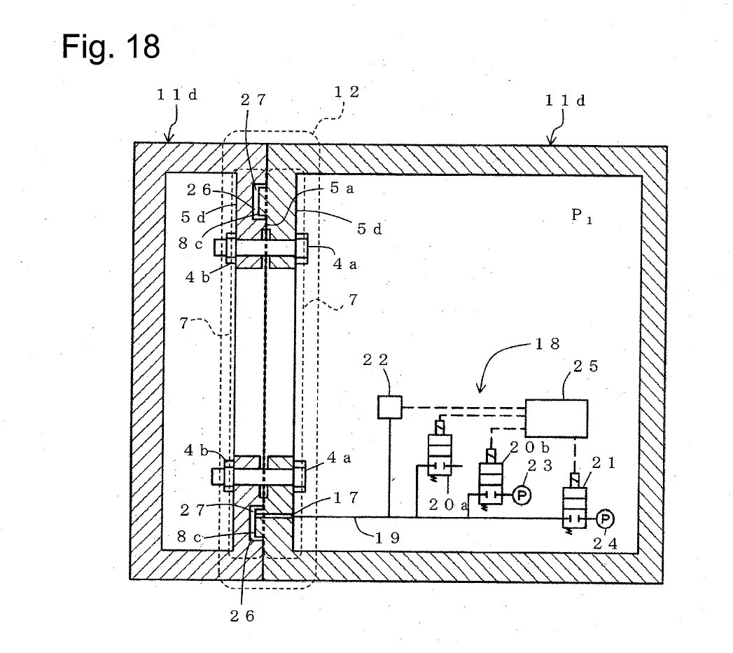

An embodiment of the joint structure of a wall member provided with sealing members 7 is described using FIG. 18. FIG. 18 is a longitudinal cross-sectional view showing a state where the sealing members 7 are used in a connecting portion 12 of a wall member 11d of a structural body such as a fuselage or a compartment of an airplane or the like. Although not showing the drawing, an output side of an open electromagnetic valve 20a is connected to a flow passage formed in a wall member 11d such that the output side of the open electromagnetic valve 20a is communicated with the outside of the structural body. Constitutional elements which are equal to the constitutional elements shown in FIG. 1 and FIG. 15 are given the same symbols and the description of these constitutional elements is omitted.

As shown in FIG. 17, the wall member 11a is formed by applying the invention of the embodiment 5 to the wall member 11a which is already described using FIG. 1. However, the structural body shown in FIG. 18 is not limited to a circular cylindrical shape as in the case of a pressurized container or a pipe, and hence a space portion 27 is formed by a groove 26 in place of forming the annular space portion 16 between the facing surfaces of the sealing members 7, 7 by the annular groove 15. In FIG. 18, to simplify the drawing, for the sake of convenience, a state is shown where air supply/discharge means 18 is connected to one of space portions 27 through an air supply/discharge hole 17. However, in an actual joint structure of a wall member, the structure is adopted where the air supply/discharge means 18 is connected to all space portions 27 through the air supply/discharge holes 17.

Such joint structure of a wall member can acquire the substantially same manner of operation and advantageous effects as the invention according to the embodiment 5.

In the embodiments 5 to 7, the structure is adopted where the annular space portion 16 or the space portion 27 is formed between the facing surfaces of the sealing members 7, 7 due to the annular groove 15 or the groove 26 and the projecting portion 8c. However, the projecting portion 8c is not an indispensable constitutional element, and hence the projecting portion 8c may be omitted. Either one of the open electromagnetic valve 20a or the air supply electromagnetic valve 21 may be omitted. The portion where the air supply/discharge hole 17 is formed is not limited to the case described in the above-mentioned embodiment, and can be changed as desired. In FIG. 18, the air supply/discharge means 18 is disposed in the inside of the structural body having the wall member 11d. However, the present invention is not limited to such a case, and for example, it may be possible to adopt the structure where the air supply/discharge means 18 is disposed outside the structural body.

### INDUSTRIAL APPLICABILITY

The inventions described in claim 1 to claim 5 are applicable to a connecting portion of a spaceship, an artificial satellite, a rocket, an airplane, a tower and vessel group, a heat exchanger, vacuum equipment, hydraulic equipment, vapor equipment, a pipe, blood flow equipment, medicine flow equipment, a pump, a valve, measuring instrument, a hermetic chamber, a ship, a submarine, a bathyscaphe, a tank group, a hose or the like.

As has been explained heretofore, the present invention is applicable to considerably versatile fields of industry. Further, the pipe joint of the present invention can be used in also in combination with conventional joints or the like, and hence the pipe joint of the present invention can be used readily. Accordingly, it is safe to say that the pipe joint of the present invention has high cost performance. Further, the pipe joint of the present invention possesses excellent earthquake resistance and safety. Still further, the pipe joint of the present invention accelerates the development of nanotechnology which is a considered promising as a future industry.

### DESCRIPTION OF REFERENCE SIGNS

1a: pipe joint
1b: pipe joint
1c: pipe joint
1d: pipe joint
1e: pipe joint
1f: pipe joint
1g: pipe joint
1h: pipe joint
1i: pipe joint
1j: pipe joint
2: flange
3: flow passage
4a: bolt
4b: nut
5a: sealing surface
5b: connecting surface
5c: inner peripheral surface
5d: pressure receiving surface
5e: pressure receiving surface
5f: pressure receiving surface
5g: outer peripheral surface
6: annular groove
7: sealing member
7a: inner peripheral surface
8a: projecting portion
8b: projecting portion
8c: projecting portion
9a: recessed portion
9b: recessed portion
10a: gasket
10b: spiral gasket
10c: gasket
11a: wall member
11b: pressurized container
11c: inner wall surface
11d: wall member
12: connecting portion
13: projecting portion
14: recessed portion
15: annular groove
15a: inner surface
16: annular space portion
17: air supply/discharge port
18: air supply/discharge means
19: air supply/discharge pipe
20a: open electromagnetic valve
20b: air discharge electromagnetic valve
21: air supply electromagnetic valve
22: pressure sensor
23: vacuum pump
24: air supply pump
25: control part
26: groove
27: space portion
P: inner pressure
P₁: inner pressure
P₂: outer pressure
P₃: inner pressure
Q: pressure

1. A pressurized container used in a state where an inner pressure is higher than an outer pressure, comprising
a connecting portion (12) where a pair of sealing members (7, 7) having a flat plate shape is disposed in a projecting manner toward the inside, each of the sealing members including a sealing surface (5a) and a pressure receiving surface (5d) on both front and back surfaces thereof, and
each of the sealing members (7, 7) is formed such that the at least one sealing surface (5a) is formed on an end surface of a projecting portion (13) formed in a projecting manner in a direction opposite to the pressure receiving surface (5d), and an area of the end surface of the projecting portion (13) is set narrower than an area of the pressure receiving surface (5d), and an area of the sealing surface (5a) is set narrower than the area of the pressure receiving surface (5d).

2. The pressurized container according to claim 1, wherein the sealing members (7) are formed such that an annular groove (6) is formed on an inner wall surface (11c) over the whole circumference near the connecting portion (12).

3. The pressurized container according to claim 1, wherein the sealing surface (5a) is constituted of a plurality of portions, and a total of areas of the portions is set as an area of the sealing surface (5a).

4. The pressurized container according to claim 1, wherein the pressurized container includes:
an annular space portion (16) formed between the facing surfaces of the sealing members (7, 7);
an air supply/discharge hole (17) formed in the connecting portion (12) such that the air supply/discharge hole has one end opened in the annular space portion (16); and
air supply/discharge means (18) connected to the other end of the air supply/discharge hole (17).

5. The pressurized container according to claim 4, wherein the pressurized container includes pressure detection means (22) which detects an inner pressure of an annular space portion (16).

6. The pressurized container according to claim 2, wherein the sealing surface (5a) is constituted of a plurality of portions, and a total of areas of the portions is set as an area of the sealing surface (5a).

7. The pressurized container according to claim 2, wherein the pressurized container includes:
an annular space portion (16) formed between the facing surfaces of the sealing members (7, 7);
an air supply/discharge hole (17) formed in the connecting portion (12) such that the air supply/discharge hole has one end opened in the annular space portion (16); and
air supply/discharge means (18) connected to the other end of the air supply/discharge hole (17).

8. The pressurized container according to claim 3, wherein the pressurized container includes:
an annular space portion (16) formed between the facing surfaces of the sealing members (7, 7);
an air supply/discharge hole (17) formed in the connecting portion (12) such that the air supply/discharge hole has one end opened in the annular space portion (16); and
air supply/discharge means (18) connected to the other end of the air supply/discharge hole (17).

9. The pressurized container according to claim 7, wherein the pressurized container includes pressure detection means (22) which detects an inner pressure of an annular space portion (16).

10. The pressurized container according to claim 8, wherein the pressurized container includes pressure detection means (22) which detects an inner pressure of an annular space portion (16).
